(19) United States
(12) Patent Application Publication
(10) Pub. No.: US 2015/0310134 A1
(43) Pub. Date: Oct. 29, 2015

(54) INTERFERENCE DETECTION IN A THREE-DIMENSIONAL DATA MODEL

(71) Applicant: Vianova Systems Finland Oy, Espoo (FI)

(72) Inventor: Jarkko SIREENI, HELSINKI (FI)

(21) Appl. No.: 14/697,958

(22) Filed: Apr. 28, 2015

(30) Foreign Application Priority Data
Apr. 28, 2014 (FI) 20145389

(51) Int. Cl. G06F 17/50; G06T 17/00

(52) U.S. Cl. CPC G06F 17/50; G06T 17/00

(57) ABSTRACT

A computer implemented method for detecting interference between elements in a three-dimensional data model. In the method the three-dimensional data model is received as an input (110), which includes plurality of elements. Input parameters (120) are also received for the interference detection between the elements in the design, which include at least a cost value for at least some of the plurality of the elements. An interference detection calculation (130) is configured to be performed with input parameters and a result of interference detection calculation is output. A system performing the method and a computer program product are also described.

### TECHNICAL FIELD

The invention concerns in general the technical field of computer aided design. Especially the invention concerns detection of designing errors in a data model.

### BACKGROUND OF THE INVENTION

3D models built with computer aided design solutions have improved the design and build of 3D structures. The design solutions have brought efficiency into many fields in designing, e.g. to infrastructure design and development.

One 3D model may consist of multiple at least partly separate 3D structures. The 3D structures, also known as elements, have exact geometry and placement in the 3D model defined in the data files representing the element in question. Many times the 3D model becomes very complex for several reasons and it is important to create tools that help overall management of the designation of the 3D model. For example, the 3D model may be designed in a collaborated manner i.e. more than one designer is taking part in the designing, and such an environment requires automatically operating tools to take care of some aspects of the designing work.

One area of interest, which needs to be monitored during the designing of the 3D model, is that the elements in the 3D model do not interfere i.e. overlap each other. This is a design error that does not exist in real world. In order to prevent the design errors ending up to the final 3D model it is important to find the overlapping elements during the design phase and refine the design so that the 3D data model does not comprise such overlapping elements in the final layout. One known method in detecting the overlapping elements in the 3D model is so called clash detection calculation. The known clash detection calculation is based on rules, which are maintained by user. The rules define the elements i.e. target objects for calculation and calculation parameters. The challenge with the known clash calculation methods is that the management of the rules gets very complicated and time consuming especially when the data models are complex and the clashes need to be determined between many combinations. There is a risk that user misses some combinations and therefore not all clashes are found. On the other hand, the known clash calculation methods produce huge amount of clashes, but all of them are shown as equal. Thus, the result may be impossible to the designer to go through within the period of time reserved for the designing process. However, any erroneous clash information in the final 3D data model may cause problems when the data model is implemented in the real world.

Still further aspect regarding the clash management and calculation is that it consumes lot of computing power of the system performing the clash calculation. One reason for this is that the 3D data models are complex and comprise great number of design elements which are taken into account in the calculations.

### SUMMARY OF THE INVENTION

An objective of the invention is to present a method, a system and a computer program product for detecting designing errors in an efficient manner. Another objective of the invention is that the method, the system and the computer program product provide a solution for detecting at least one object interfering with at least one other object in a design.

The objects of the invention are reached by a method, an apparatus and a computer program as defined by the respective independent claims.

According to a first aspect, a computer implemented method for detecting interference between elements in a three-dimensional data model is provided wherein the method comprises at least the following phases: receiving the three-dimensional data model as an input, the three-dimensional data model comprising plurality of elements; receiving input parameters for the interference detection between the elements in the design, the input parameters comprising at least a cost value for at least some of the plurality of the elements in the three-dimensional data model; performing an interference detection calculation with input parameters; and outputting a result of interference detection calculation, the result disclosing at least one interference between plurality of elements at least partly on the basis of the cost value in response to a detection of an interference.

The result of interference calculation may disclose two or more elements causing the interference in the three-dimensional data model, wherein the interference between the elements exceeds a pre-determined limit.

The elements causing the interference may be listed at least partly in view of cost value. The elements may be listed in an order of importance based at least partly on the cost value defining the at least one element to be manipulated in order to remove the at least one interference.

The step of receiving input parameters for the interference detection may comprise a receipt of ending criterion for the interference detection calculation. The ending criterion may be a detection of pre-determined number of interferences exceeding a pre-determined cost value.

According to a second aspect, a system for detecting interference between elements in a three-dimensional data model is provided wherein the system comprises one or more processors, one or more memories including computer program code, the memory and the computer program code configured to, with the processor, cause the system at least to perform the following: receive the three-dimensional data model as an input, the three-dimensional data model comprising plurality of elements; receive input parameters for the interference detection between the elements in the design, the input parameters comprising at least a cost value for at least some of the plurality of the elements in the three-dimensional data model; perform an interference detection calculation with input parameters; and output a result of interference detection calculation, the result disclosing at least one interference between plurality of elements at least partly on the basis of the cost value in response to a detection of an interference.

The system may be configured to disclose, as the result of interference calculation, two or more elements causing the interference in the three-dimensional data model, wherein the interference between the elements exceeds a predetermined limit.

The system may be configured to list the elements causing the interference in at least partly in view of cost value. The system may be configured to list the at least one element to be manipulated in order to remove the at least one interference, wherein the elements are listed in an order of importance based at least partly on the cost value.

The system may be configured to receive an ending criterion for the interference detection calculation during the step of receiving input parameters for the interference detection. The system may be configured to receive a detection of pre-determined number of interferences exceeding a pre-determined cost value as the ending criterion for the interference detection calculation.

According to a third aspect, a computer program product comprising at least one computer readable non-transitory medium having program code stored thereon is provided wherein the program code, when executed by a system, causes the system at least to perform method, either partly or in full, as disclosed above.

The exemplary embodiments of the invention presented in this patent application are not to be interpreted to pose limitations to the applicability of the appended claims. The verb “to comprise” is used in this patent application as an open limitation that does not exclude the existence of also un-recited features. The features recited in depending claims are mutually freely combinable unless otherwise explicitly stated.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF DRAWINGS

FIG. 1 illustrates an example of a method according to the invention,

FIG. 2 illustrates an example of input parameters according to the present invention,

FIGS. 3a and 3b illustrate non-limiting examples of the outcome of the clash detection calculation according to an example of the invention,

FIG. 4 illustrates an example of a system according to the invention.

### DETAILED DESCRIPTION

3D data models allow visualization of a design before it is built. Such models illustrate placements of elements in relation to each other. The elements are objects in the 3D data model, which objects are created by design software. In typical projects there are multiple design software used for multiple design disciplines. Therefore typical combined model, which is used for clash detection, is a collection of objects from multiple sources. Objects can be read to the combined model by reading multiple external data model files or by reading objects directly from design software. Normally open data model standards like GML, XML and IFC (STEP) are used for linked files. Each linked file may consist of multiple objects of different type. The aim of the present invention is to mitigate design errors relating to mutual interference (i.e. clashes) of objects in the 3D data model with an improved clash detection solution.

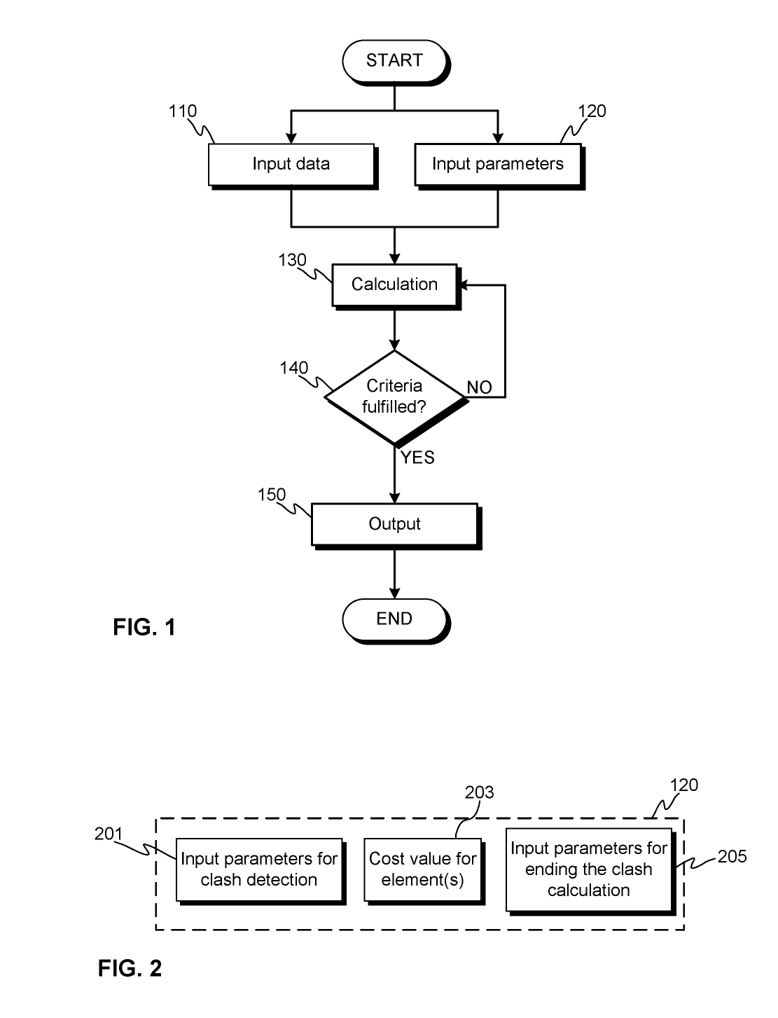

FIG. 1 discloses an example of a method according to the invention as a flow chart. The method as disclosed in FIG. 1 may be implemented with any system having the resources to perform the operation. Such a system may e.g. be any computing device like a personal computer, a server, a mobile device or any combination of one or more of these or a specific circuit arranged to implement the method. The method according to the invention may be implemented as a software application residing in a memory of the system. The memory is configured to communicate a processor in the system, which is arranged to executing the software application. The memory and the processor may consist of one or more memory elements and processor units. Furthermore, the memory may be arranged remotely to the system and the software application is configured to be executed remotely by the processor in the system.

At steps 110 and 120 the input information is transmitted to the process according to the invention. The input information comprises at least input data 110 and input parameters 120. Input data refers to 3D data model comprising elements, whose mutual interference is analyzed. More specifically, the 3D data model comprises definitions for the elements belonging to the 3D data model. The definitions comprise at least geometrical definition on the three dimensional shape and structure of the element as well as placement information of the element within the 3D data model. Definitions may also contain element textual or numerical attributes like dimensions, volume, weight, materials, type, manufacturer etc. Additionally, parameters for the clash detection calculation may be input as input parameters 120. The input parameters 120 advantageously control at least the clash detection algorithm. The input parameters 120 may, for example, be calculation tolerances, list of objects to be used in calculation, calculation ending or any other parameter that effect how clash calculation works. The input of the input parameters 120 may be arranged so that the user of the system inputs the parameters through a user interface prior to the clash calculation. The system may be arranged to prompt the requested input parameters 120 until they are input or the whole procedure is canceled by the user. Alternatively or in addition, if the user doesn't define any input parameters 120 and wants to proceed with the calculation, the computer program configured to perform the clash calculation may utilize predefined default parameters defined in the computer program or stored in a location accessible to the computer program.

According to an example of the present invention a cost value is configured to be input by the user for at least some, typically for each, model element or sets of elements as an input parameter 120. The cost value reflects the possible cost of a clash in the data model if the clash is not detected and/or removed. According to an example of the invention the bigger the value is, the more serious the found clash is. Alternative ways to indicate the seriousness of a clash of an element may be defined. The cost value is used as an input parameter in the clash detection algorithm to prioritize elements during calculation and to sort results. In other words the aim is to determine the model elements, whose clashes may cause the most serious effects in the data model. Naturally, the effect in the data model corresponds, at least in some extent, to the effect in real world implementation of the designed data model. The input of the cost value to a designed model element may be arranged so that a user defines the cost value for each of the elements or sets of elements prior to initiating clash detection calculation. The clash detection tool may be configured to analyze all elements or sets of elements in the 3D data model input to the tool and provide a list of elements or sets of elements for the user to whom the user is requested to input cost values. According to some other example of the present invention the designing software may be configured to store the input cost values to a metadata of the data model, which enables a later use of the same cost values if and when the data model is changed.

Furthermore, some input parameters may relate to the clash detection calculation itself as mentioned. The user may e.g. define an ending criterion or ending criteria for the clash calculation by inputting an applicable value or applicable values in the system. By adjusting the ending criterion for the calculation it is possible to limit the duration of the clash calculation as well as resources needed for the calculation. An example of the ending criterion may be a maximum calculation time or maximum found clashes. Furthermore, the ending criterion may be a maximum number of found clashes of certain cost value. If no ending criterion, or criteria, is set, calculation continues until no clashes are found any more.

FIG. 2 illustrates an example according to the present invention disclosing the input parameters 120 for the method. The input parameters comprise parameters for the clash detection algorithm itself 201, such as tolerances of the elements as described above. Additionally, the input parameters 120 defining the cost value for elements or sets of elements 203 are input. Moreover, an ending criterion or criteria for the clash calculation 203 may be input. The input parameters 120 are not limited only to these, but the mentioned ones are at least needed for implementing the present invention.

The mentioned input parameters 203 for the clash calculation may be input at different instances. For example, at least part of the input parameters 120 may be input when the clash calculation application is installed in the system and the parameters are set as default values in the application. In practice this means that the parameters are stored in a memory accessible to the system and the clash calculation application. Alternatively, the parameters may be input when the clash calculation application is activated i.e. taken into use. The clash calculation application may be configured to receive and analyze the data model as an input data 110 and request the parameters in response to the analysis. For example, this approach may be utilized with respect to the cost values 203. Depending on an implementation of the clash detection tool the input of the parameters may be arranged so that the clash detection calculation is not performed before all requested input parameters are given. According to some other implementation of the present invention the clash calculation may be performed when at least some parameters, which are defined compulsory, are input by the user. For example, the cost values 203 may be defined compulsory but the ending criteria 205 for the clash detection algorithm may not necessarily be compulsory.

When all the necessary information i.e. the 3D data model and the necessary parameters for the clash calculation are input the application is configured to call the clash calculation procedure defined by the computer program code. As a result, the clash calculation procedure is initiated 130.

During the clash calculation 130 the application is configured to iteratively monitor if the predetermined criterion or criteria for ending the clash calculation is fulfilled 140. If the criterion or criteria are not fulfilled, the calculation is continued (negative path in FIG. 1). If the criterion or criteria are fulfilled, the clash calculation application is configured to cancel the execution of the clash detection algorithm with a predefined instruction defined in the computer program code. In response to the cancellation of the clash calculation the application is configured to output 150 the result of the calculation in a predetermined manner.

The output of the results from the clash calculation may be performed in multiple ways. According to first aspect of the invention the output refers to storing of the data representing the detected clashes in the 3D data model in a memory accessible by the system. Alternatively or in addition, the output may refer to displaying of the results to the user. The visualization may be implemented so that at least part of the detected clashes may be shown as a list to the user, wherein the one or more clashes may be selected into the list at least partly based on, i.e. in view of, cost value determined to at least one of the following: any object being involved in a clash, a combined cost value determined for objects being involved in a clash, as will be discussed below. Alternatively or in addition, at least part of the detected clashes may be highlighted in a known manner, such as with a marking or with a color, in the 3D data model so that it is easy for the user to detect the clashes fulfilling the predetermined criteria. Advantageously, the output of the results is arranged so that the most serious clashes are indicated in a different manner than the less serious ones. This can be done with visualization or in case of list so that the most serious clashes are listed first. The determination of the most serious clashes may be based on a pre-determined calculation by using a cost value of one or more elements being involved in the clash as a parameter in the calculation. According to an example of the invention, the calculation may be performed simply by summing up the cost values of the elements being involved in the clash producing cost values for each of the clashes. By listing at least part of the detected clashes on the basis of the calculation in a predetermined order it is possible provide information to the user on the most important clashes. It is possible to develop any calculation methods for determining the most important clashes from the data model in question. It is possible to use some statistical methods, such as averaging, in the calculation. In some implementation of the invention the clash detection tool may comprise multiple different calculation methods which may be selected by the user.

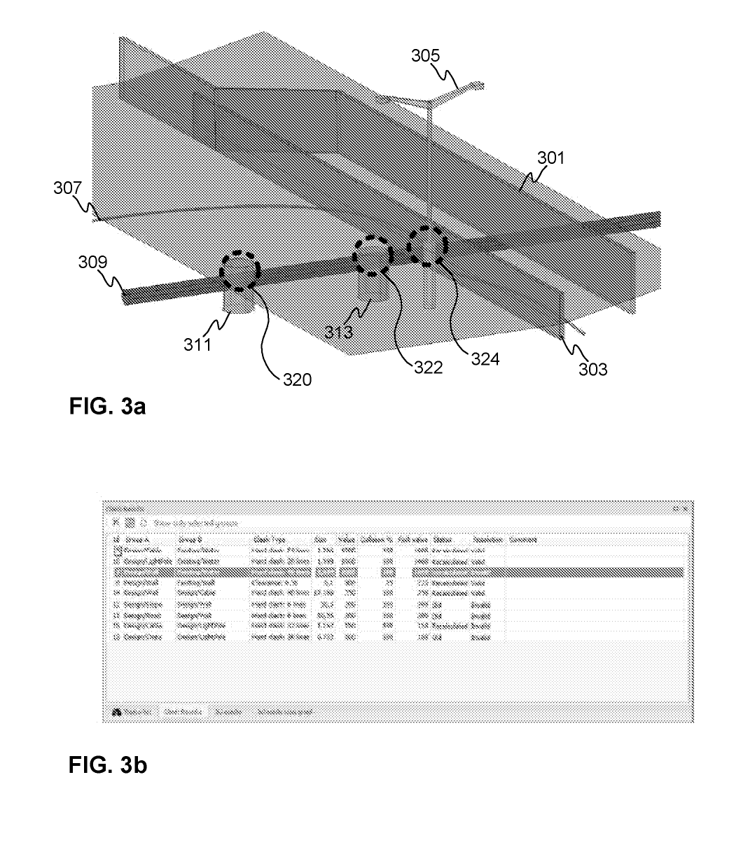

FIG. 3a and FIG. 3b illustrate non-limiting examples of the outcome of the clash detection calculation according to an example of the invention. The 3D data model comprises into which the clash detection calculation is to be performed the following elements: an existing wall in the environment 301, a new wall (designed) 303, a light pole 305, an electric line 307, a waterline 309, manholes 311, 313. The user performing the clash detection may give the following cost values (see column in right) for the elements in the 3D data model:

| Reference | | |
|---|---|---|
| number | Element name | Cost value |
| 301 | Existing wall | 600 |
| 303 | New wall | 300 |
| 305 | Light pole | 100 |
| 307 | Electric line | 50 |
| 309 | Waterline | 1000 |
| 311, 313 | Manhole | 1000 |

Based on the cost values input as input parameters 120 the clash detection tool is configured to determine the clashes in the 3D data model and point out at least some of the detected clashes. The output of the clashes may be arranged either directly in the model. In the FIG. 3a some most important clashes are visualized with circles of dash line 320, 322, 324. As can be seen the cost values for manholes 311, 313 and waterline 309 are the highest and thus they are pointed out. Moreover, the cost values for the new wall 303, the light pole 305 and the waterline 309 are also high and the clash is pointed out with the circle 324. In some implementation of the invention the user may receive further information on each of the clashes by moving a pointer to the circle on the display and the clash detection tool may provide a prompt disclosing the information on the elements of the clash as well as any further information on the clash itself. FIG. 3b illustrates another way of disclosing the detected clashes in the data model. In FIG. 3b the clashes are illustrated as a list in an order of importance. The list illustration preferably points also out the one or more other elements with whom a certain element clashes, but also some other information. For example, it is possible to calculate some indication, such as collision percentage, disclosing the amount how much the elements are clashing each other. FIGS. 3a and 3b are examples of the present invention but the invention is not limited to these examples only.

The cost values, as already mentioned, may be given by a user performing the clash analysis. In some implementation of the invention some pre-determined cost values may be stored in the system to be utilized in the clash detection calculation. The cost values may be given and determined by following some pre-determined rule. For example, the cost value may be higher when the element in question is such that it requires costly re-construction operations if the possible clash ends up into real world implementation. The detected clashes in the order of importance may also point out those elements, which are less valuable and thus easier to be manipulated, such as re-located or re-modified, in the data model in order to remove the clash or clashes in question.

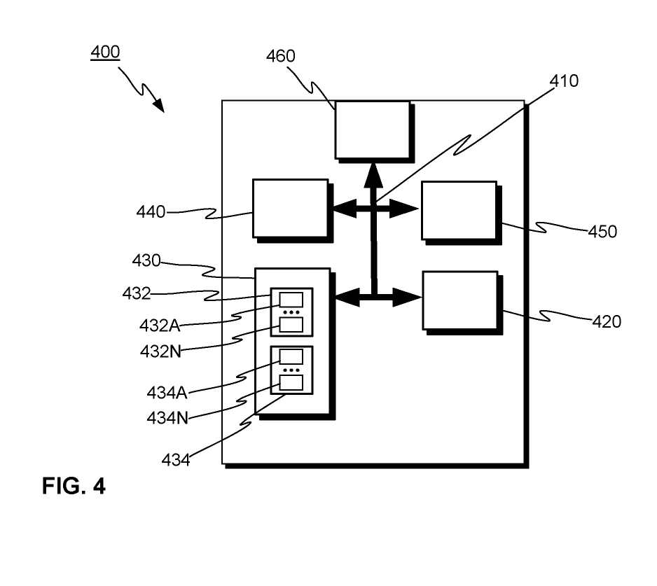

The invention also relates to a system which is configured to implement the method as described above. A system according to an example of the invention is illustrated in FIG. 4. The system 400 comprises, for example, a bus 410, a processor 420, a memory 430, input means 440, output means 450, and a communication interface 460. The bus 410 may include means or methods that enable communication among the elements of the system 400. The system may comprise, or be implemented by, one or more servers, one or more desktop computers, one or more laptop computers, one or more tablet computers, one or more mobile communication terminals or one or more special hardware devices as long as it is capable of implementing the method according to the invention. Thus, in principle any system, which comprises, or have access on, necessary hardware and computer program code stored in a memory, may be configured to implement the method as described.

The processor 420 may comprise one or more conventional processors, one or more microprocessors, or one or more processing logics, or any combination of these, that interprets and executes instructions defined by portions of computer program code. The memory 430 may comprise a random access memory (RAM) 432 and/or a read only memory (ROM) 434. The RAM 432 may store information and instructions in a form of portions of computer program code 432A-432N for execution by the processor 420. The ROM 434 may include a conventional ROM device or another type of a static storage device that is configured to store static information and instructions in a form of portions of computer program code 434A-434N for use by the processor 420. The RAM 432 and ROM 434 may be implemented with one or more corresponding memory elements.

The input means 440 may comprise a conventional mechanism that permits inputting information to the system 400, such as a keyboard, a mouse, a pen, a touch screen, voice recognition and/or biometric mechanisms, CD/DVD/Blue-ray drive etc. The output means 450 may comprise a conventional mechanism that outputs information, including a display, a printer, a speaker, etc. The input and output means are not necessarily implemented into the system 400, but may be coupled to the system 400 with some known interfaces either wirelessly or in a wired manner when needed. In some examples of the invention the system does not comprise any input means 440 or output means 450 as the system operates as a standalone entity, which is controlled externally through the communication interface 460.

The communication interface 460 may enable the system 400 to communicate with other elements and/or systems, such as networks, as well as with client terminals either directly or indirectly over a network.

The system 400 may perform the operations as described above in response to the processor 420 executing at least one instruction defined in portions of computer program code contained in the computer-readable medium, such as memory. A computer-readable medium may be defined as a physical or logical memory device. The software instructions may be read into the memory from another computer-readable medium, such as a data storage device, or from another device via the communication interface 460. The software instructions may cause the processor 420 to perform method steps and processes as described and thus to enable the operation of the system 400 according to an example of the invention.

As said, FIG. 4 illustrates an example of the system 400 according to the invention. The elements as disclosed in FIG. 4 do not necessarily exist in all implementations of the system 400. For example, the system 400 may not comprise input means 440 and output means 450, but the system 400 may be accessed through the communication interface 460 with applicable devices and systems. As well, the number and type of memories may vary. Further, the amount of portions of computer program code may depend on the implementation.

The system 400 is configured, by means of at least part of the mentioned elements, to implement the method according to an example of the invention. The system 400 may be any device that receives the 3D data model 110 and parameters 120 as an input through e.g. the communication interface 460 and a user interface, performs the described method steps and returns information on clashes fulfilling the criteria as defined.

An example of the invention also relates to a non-transitory computer-readable storage medium, which stores at least portions of computer program code, wherein the portions of computer program code are computer-executable to implement the method steps in the system as described. In general, the computer-readable storage medium may include a storage medium or memory medium, such as magnetic or optical media e.g. disc, DVD/CD-ROM, volatile or non-volatile media, such as RAM. The computer program code may be written in any form of programming language, including compiled or interpreted languages, and the computer program may be deployed in any form, including as a stand-alone program or as a subroutine, element or other unit suitable for use in a computing environment. A computer program code may be deployed to be executed on one computer or on multiple computers at one site or distributed across multiple sites and interconnected by a communication network. The computer program code comprises instructions for causing the system to perform one or more of the method steps as described above.

For the sake of clarity the clash detection tool may be a separate application, which may be called by a user of the system or another application either automatically or on request. Moreover, the clash detection tool may be implemented within another application, such as designing tool, as an option to be used if needed.

Some advantageous embodiments according to the invention were described above. The invention is not limited to the embodiments described. The inventive idea can be applied in numerous ways within the scope defined by the claims attached hereto.

1. A computer implemented method for detecting interference between elements in a three-dimensional data model, the method comprising:
receiving the three-dimensional data model as an input (110), the three-dimensional data model comprising plurality of elements,
receiving input parameters (120) for the interference detection between the elements in the design, the input parameters comprising at least a cost value for at least some of the plurality of the elements in the three-dimensional data model,
performing an interference detection calculation (130) with input parameters, and
outputting (150) a result of interference detection calculation, the result disclosing at least one interference between plurality of elements at least partly on the basis of the cost value in response to a detection of an interference.

2. The computer implemented method of claim 1, wherein the result of interference calculation disclosing two or more elements causing the interference in the three-dimensional data model, wherein the interference between the elements exceeding a pre-determined limit.

3. The computer implemented method of claim 1, wherein the elements causing the interference are listed at least partly in view of cost value.

4. The computer implemented method of claim 3, wherein the elements are listed in an order of importance based at least partly on the cost value defining the at least one element to be manipulated in order to remove the at least one interference.

5. The computer implemented method of claim 1, wherein the step of receiving input parameters (120) for the interference detection comprises a receipt of ending criterion for the interference detection calculation (130).

6. The computer implemented method of claim 5, wherein the ending criterion is a detection of pre-determined number of interferences exceeding a pre-determined cost value.

7. A system (400) for detecting interference between elements in a three-dimensional data model, the system comprising
one or more processors (420)
a memory (430) including computer program code
the memory (430) and the computer program code configured to, with the processor (420), cause the system (400) at least to perform:
receive the three-dimensional data model as an input, the three-dimensional data model comprising plurality of elements,
receive input parameters for the interference detection between the elements in the design, the input parameters comprising at least a cost value for at least some of the plurality of the elements in the three-dimensional data model,
perform an interference detection calculation with input parameters, and
output a result of interference detection calculation, the result disclosing at least one interference between plurality of elements at least partly on the basis of the cost value in response to a detection of an interference.

8. The system (400) of claim 7, wherein the system is configured to disclose, as the result of interference calculation, two or more elements causing the interference in the three-dimensional data model, wherein the interference between the elements exceeds a pre-determined limit.

9. The system (400) of claim 7, wherein the system is configured to list the elements causing the interference at least partly in view of cost value.

10. The system (400) of claim 9, wherein the system is configured to list the at least one element to be manipulated in order to remove the at least one interference, wherein the elements are listed in an order of importance based at least partly on the cost value.

11. The system (400) of claim 7, wherein the system is configured to receive an ending criterion for the interference detection calculation during the step of receiving input parameters for the interference detection.

12. The system of claim 11, wherein the system is configured to receive a detection of pre-determined number of interferences exceeding a pre-determined cost value as the ending criterion for the interference detection calculation.

13. A computer program product comprising at least one computer readable non-transitory medium having program code stored thereon, the program code, when executed by a system, causing the system at least to perform method steps according to claim 1.
